(19) United States
(12) Patent Application Publication
(10) Pub. No.: US 2013/0019092 A1
(43) Pub. Date: Jan. 17, 2013

(54) System to Embed Enhanced Security / Privacy Functions Into a User Client

(71) Applicant: ZACHARY LEVOW, MOUNTAIN VIEW, CA (US)

(72) Inventor: ZACHARY LEVOW, MOUNTAIN VIEW, CA (US)

(73) Assignee: BARRACUDA INC., CAMPBELL, CA (US)

(21) Appl. No.: 13/183,403

(22) Filed: Jul. 14, 2011

(51) Int. Cl. H04L 9/00; G06F 21/00; G06F 15/173

(52) U.S. Cl. 713/155; 709/226; 726/26

(57) ABSTRACT

A system and method for provisioning enhanced security/privacy functions into a user client to detect, warn, and avoid man in the middle attacks and to improve privacy and security of data transmitted across the Internet without certificate authorities.

### RELATED APPLICATIONS

None

### BACKGROUND

Conventional web application security is provided by browser executed libraries which trust a list of Certificate Authorities which came preinstalled and then configured by the administrator of a local area network. However users or applications may not be well served by administrators who furnish compromised CA's and which are vulnerable to man in the middle attacks (MITM).

Man in the Middle attacks exploit well known vulnerabilities and are not easily detected by users.

A conventional client server configuration, as shown in FIG. 1A, such a browser communicatively coupled to a website 250 through the Internet may provide a secure HTTP protocol using Secure Sockets Layer or Transport Layer Security (SSL/TLS) modules for authentication and encryption. This is accomplished by negotiating a handshake using a certificate 251 signed by a certificate authority which is in a list 211 of trusted certificate authorities installed in the user client 210 by default or configuration. One known problem, illustrated in FIG. 1B, may occur when traffic between the client 210 and the server 250 is intercepted by a Man in the Middle (MitM) attacker 230, which presents a certificate 231 claiming to be that of the destination server. If the trusted Certificate Authority (CA) list of the user client includes the CA which signed the MitM certificate, the user is fooled into connecting to the Man in the Middle, which decrypts, reads, and reencrypts the traffic before sending on to the server and likewise decrypts, reads, and forwards the response from the server. Thus it can be appreciated that what is needed is a solution to detect an attack and/or protect a client-server transaction from an attack when a user client's list of trusted CA's includes the signer of certificates presented by a Man-in-the-Middle attacker 212.

### BRIEF DESCRIPTION OF FIGURES

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIGS. 1-8 a schematics of systems embodying the inventions; and

FIG. 9 is a flow chart of a method embodiment.

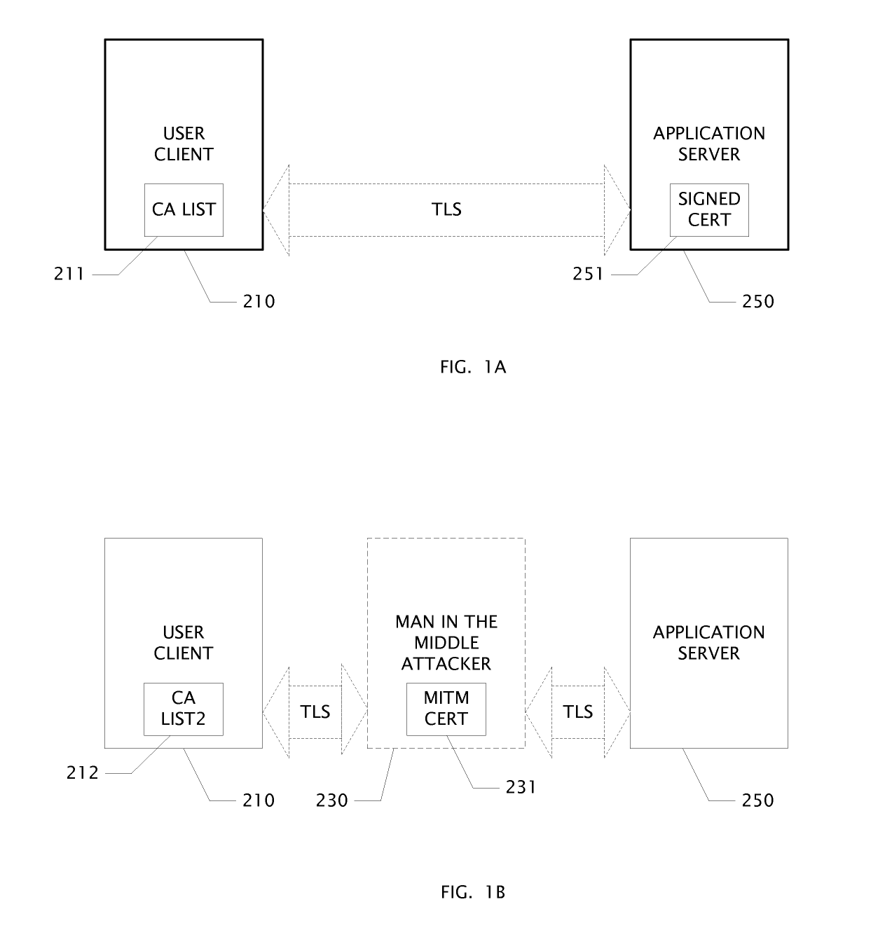

### SUMMARY OF THE INVENTION

An application server comprises a resource accessible by a uniform resource identifier and a plurality of functions. Upon request from a user client, the server provides a resource which contains one of the application embedded functions which protect content of a data field by encryption or obfuscation. In some cases the function may be machine generated and never repeat the same transformation. In an embodiment the function may be in the form of obfuscated javascript. In some cases the application server may not test the certificate or proxy that is associated with the user client. It may assume that there is a Man in the Middle attack and that the certificates installed on the browser or on a proxy between the browser and the server are compromised. The function may be referenced or included in a response to a request and executes within a browser to transform the data prior to transmission.

It is understood among those skilled in the art that a server may not be a separate physical server and may not only share hardware resources but also share software with an application store. It is described separately solely for clarity of understanding as separably inventive.

### DETAILED DISCLOSURE OF EMBODIMENTS OF THE INVENTION

A data transformation method operates within a user client to transform data before transport. In an embodiment, the transformation is encryption or obfuscation. A function is directly or indirectly provisioned by an application server upon a request for a resource. The function may be dynamically generated or selected pseudo-randomly from among a plurality of functions which are programmed to perform different transformations on data at the user client. While a man in the middle attacker may be able to read the function, it will not be able to access the data originating at the user client until after the function transforms it. The function may provide authentication, encryption, obfuscation, or examine certificates and provide warnings to the user. The function may redirect the user to a different trusted proxy than it is configured for. The function may implement a compression or encryption tunnel within a less trusted or less efficient tunnel.

The function may be a javascript, a plugin, a flash program, or redirect the browser to use a different server or proxy. The function may use a key that is stronger than conventional certificates.

One embodiment of the invention is a method for operating a application website comprising:
providing a resource at a uniform resource identifier;
receiving an http or https request;
transmitting an http or https response which includes a function;
receiving data that has been transformed by the function; and
removing the transformation of data which was operated on by the application embedded function.

In an embodiment the function comprises a javascript program.

In an embodiment the function comprises a flash program.

In an embodiment the function obfuscates a form field before it is uploaded to a server.

In an embodiment the function encrypts contents of a form field before it is uploaded to a server.

An embodiment of the invention is an apparatus comprising a server and a security/privacy function injection circuit communicatively coupled to a network interface whereby security/privacy functions are selected and injected into HTTP(S) responses when a resource is requested by a user client.

In an embodiment the apparatus has a security/privacy function store communicatively coupled to the security/privacy function injection circuit comprising at least one of:
instructions to inject security/privacy functions into an HTTP(S) RESPONSE;
instructions to display a message to install a security/privacy application;
instructions to redirect a user client to a trusted proxy;
instructions to obfuscate user data;
instructions to select or generate a key;
instructions to encrypt user data with a key known to the website server;
instructions to authenticate the certificate of a website;
instructions to download a security/privacy function from an application store; and
instructions to embed a security/privacy function into a user client.

In an embodiment the security/privacy function store is configured as a publicly accessible application repository coupled to the Internet.

Another aspect of the invention is an apparatus comprising a server and a security/privacy function repository communicatively coupled to a network interface whereby security/privacy functions are selected and included with responses when a resource is requested by a user client.

In an embodiment, the security/privacy function repository is communicatively coupled to a plurality of servers which may select from available security/privacy functions to reference in response to a request from a user client.

In an embodiment, the repository is configured to provision a function to a user client when a connection to a server is requested by a user client.

In an embodiment, the apparatus further comprises a security/privacy function repository comprising at least one of:

instructions to include security/privacy functions in an HTTP RESPONSE;

instructions to display a message to install a security/privacy application;

instructions to redirect a user client to a trusted proxy;

instructions to obfuscate user data;

instructions to select or generate a key;

instructions to encrypt user data with a key known to the website server;

instructions to authenticate the certificate of a website;

instructions to download a security/privacy function from an application store; and

instructions to embed a security/privacy function into a user client.

In an embodiment, the security/privacy function store is further configured as a publicly accessible application store coupled to the Internet.

An other aspect of the invention is a method for providing a service to configure a user client for a secure communication connection with a remote server comprising:
receiving a security/privacy function in response to a initiation of a connection to the remote server;
exchanging with the server parameters to mutually configure the user client and the remote server to transform data and remove the transformation;
operating the function on data within the user client to transform the data; and
transmitting the transformed data to the remote server.

In an embodiment, the function comprises a javascript program.

In an embodiment, the function comprises a flash program.

In an embodiment, the function obfuscates a form field before it is uploaded to an application web server.

In an embodiment, the function encrypts contents of a form field before it is uploaded to an application web server.

In an embodiment, the method further comprises: providing a security/privacy function repository communicatively coupled to a network interface whereby security/privacy functions are selected and included with responses when a resource is requested by a user client.

In an embodiment, the security/privacy function repository is communicatively coupled to a plurality of servers which may select from available security/privacy functions.

In an embodiment, connection does not rely on possession of a digital certificate signed by a trusted certificate authority.

In an embodiment, providing the security/privacy function is operated as a service to multiple unaffiliated customers.

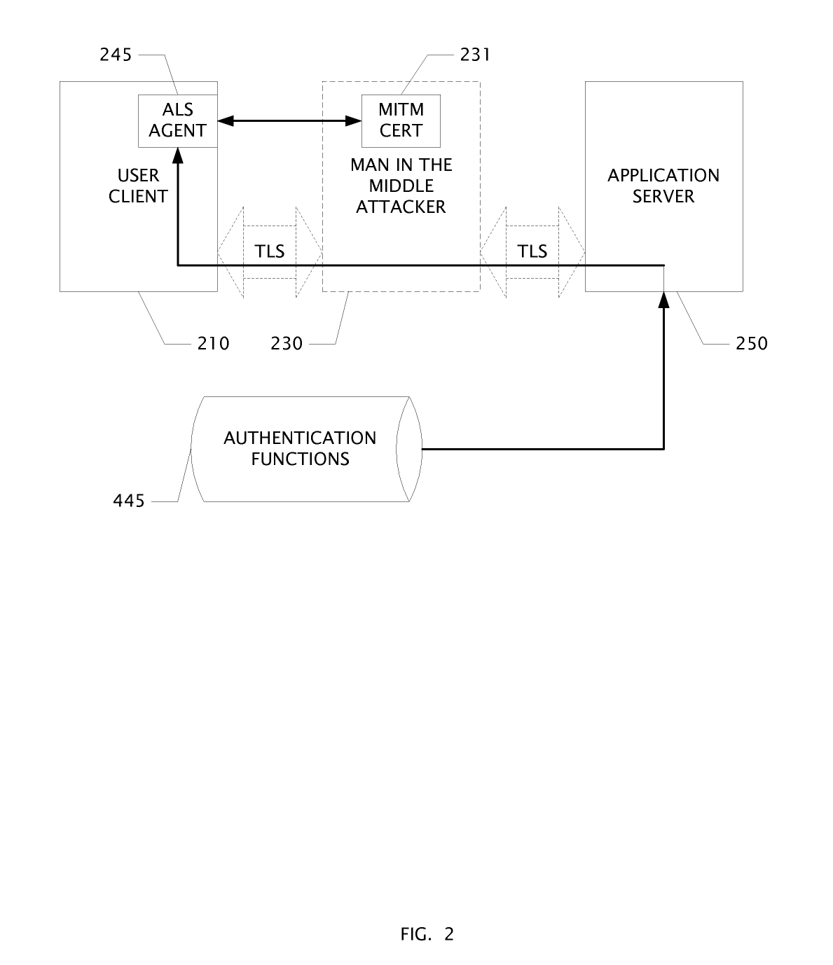

Referring now to the figures, one embodiment of the invention shown in FIG. 2 includes an authentication functions store 445 coupled to an application server 250. When a user client 210 requests a resource, the response from an application server 250 includes at least one authentication function. An Application Layer Security (ALS) agent is installed within the user client and warns the user when the certificate provided by the Man-in-the-Middle fails to be verified as that of the Application Server 250. Of course browsers already inform the user if the MitM Cert is invalid with respect to the list of trusted Certificate Authorities installed in the user client. The ALS agent may also inform the Application Server. The ALS agent may also obscure the data visible to the MitM without offering the user an opportunity for a social engineering attack. The ALS agent may terminate the session.

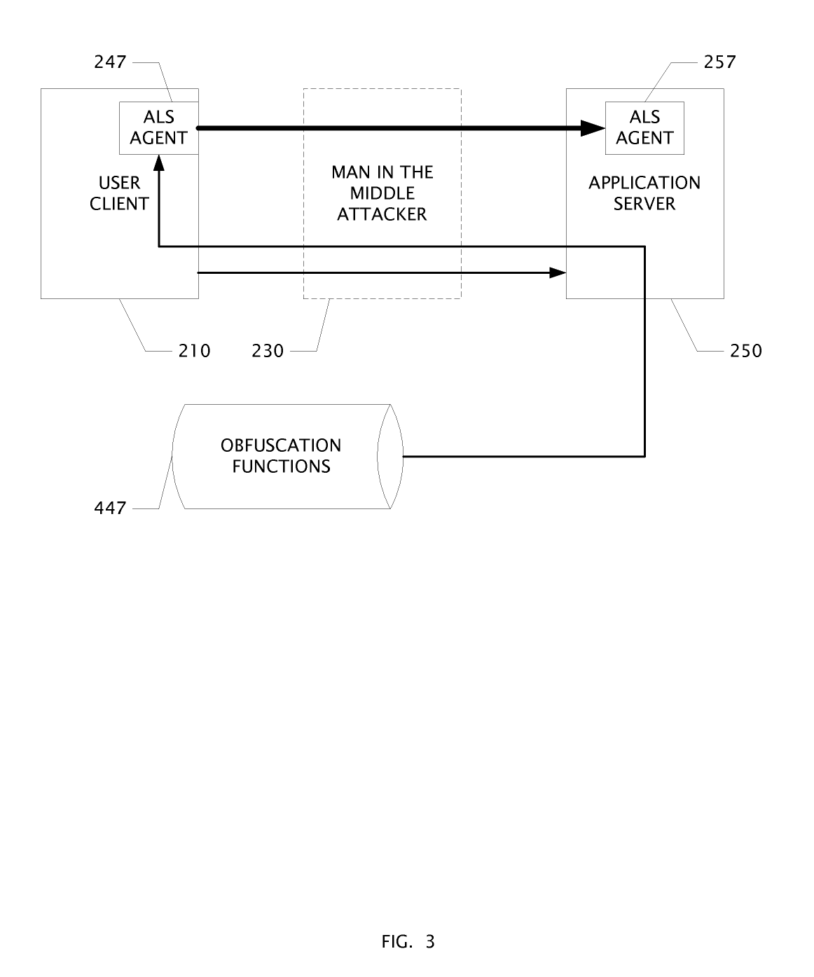

Referring now to FIG. 3, a request for a resource submitted to an Application Server 250 may have low value or a short expiration date for validity in which case the Application Server selects from a store of obfuscation function which do not incur the higher overhead of handshaking or encryption. For example, guessing a shared secret may amuse the MitM attacker long enough that the data will become stale or superseded In this embodiment, the Application server selects from among a plurality of obfuscation functions in a store 447, transmits a requested resource including the function to the user client and receives and reverses the obfuscation in an ALS agent 257.

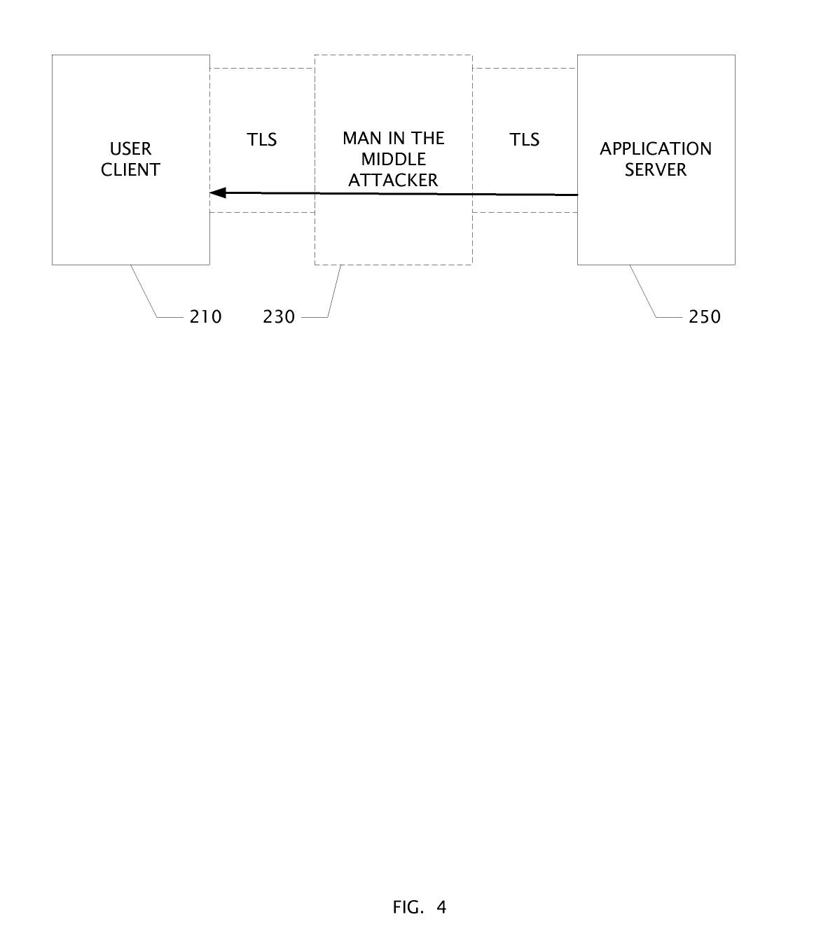

Referring now to FIG. 4, for high value data such as personal or financial records, much more care must be taken. While not essential to the invention, it is helpful to appreciate the method to assume that a MitM attack has successfully intermediated all the traffic between a user client 210 and an application server 250. In the illustration a TLS connection has already been established by the MitM attacker to the both the user client and the application server. We shall illustrate how to overcome the attack by an embodiment of the invention.

At the client 210, a request is submitted to an application server 250 for a resource through the TLS connection. At the application server, a request is received and a response is transmitted including at least a reference to a function.

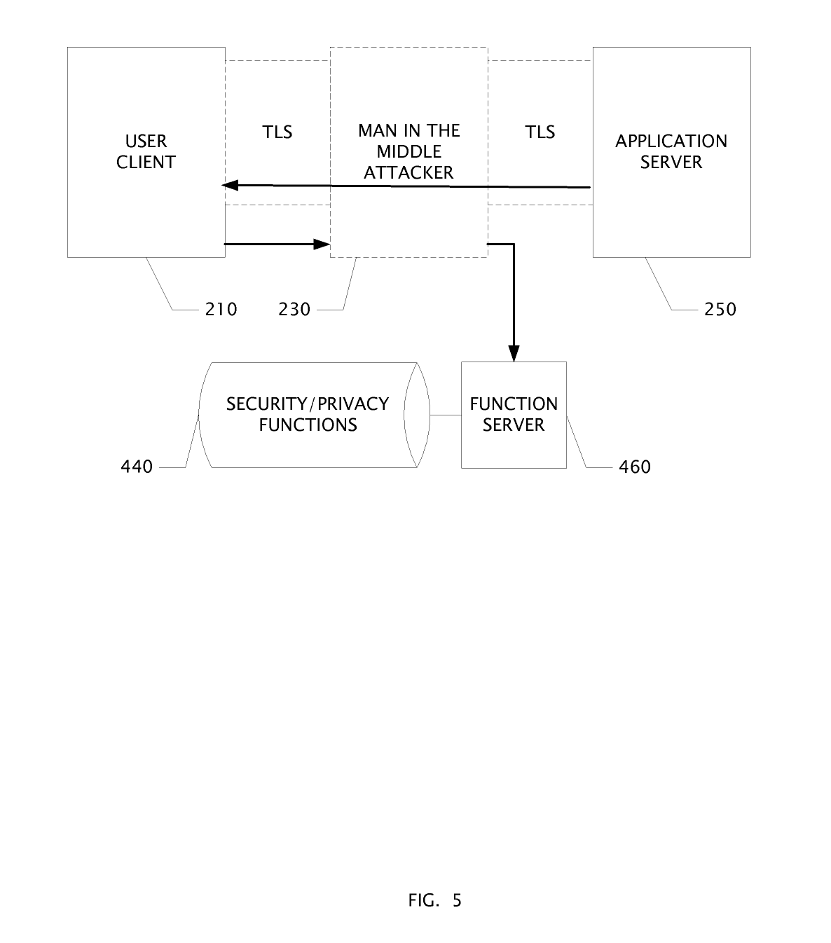

Referring now to FIG. 5, the user client receives the resource and requests a function from the function server 460. In an embodiment the function includes authentication, obfuscation, or encryption or two of the three, or all three, or other functions.

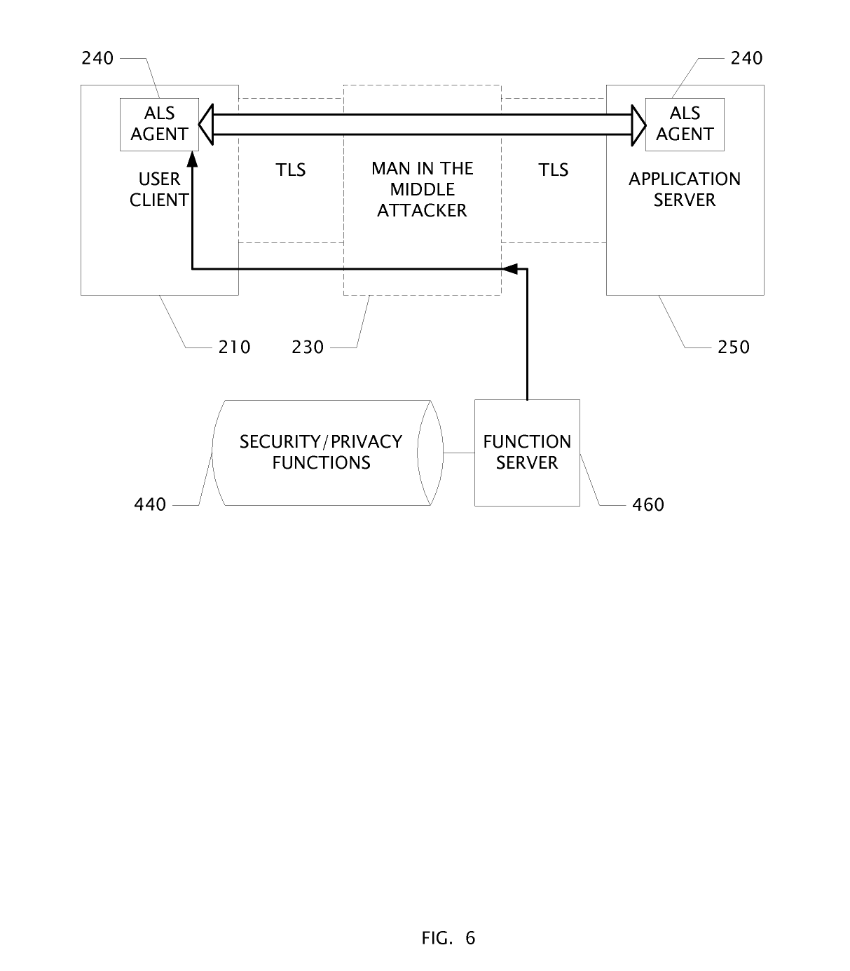

Referring now to FIG. 6, at the user client 210 a function is received from the function server 460, an Application Layer Security agent is installed 240, and a handshaking protocol is negotiated with an Application Layer Security agent 240 installed within the application server 250 which authenticates the user and creates an encrypted tunnel within the TLS connection. The encrypted ALS tunnel does not depend on signed certificates or trusted certificate authorities.

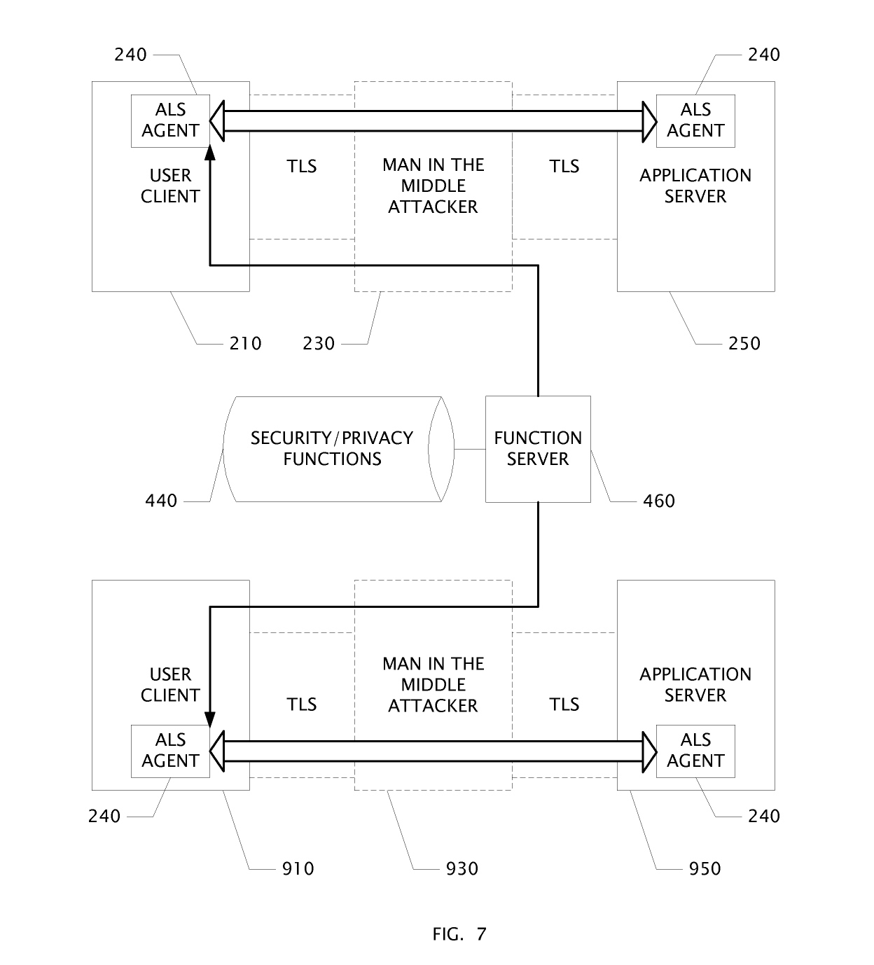

Referring now to FIG. 7, a plurality of application servers 250, 950 is each enabled to operate an Application Layer Security agent. When each server receives a request for a resource a response references a function server 460 which selects from a plurality of security/privacy functions in a store 440. For each application, the function server may provide an authentication function, an obfuscation function, an encryption function or a combination of two or three types. Furthermore, the function server dynamically obfuscates and modifies the functions so that MitM attackers cannot identify the functions by name or signature.

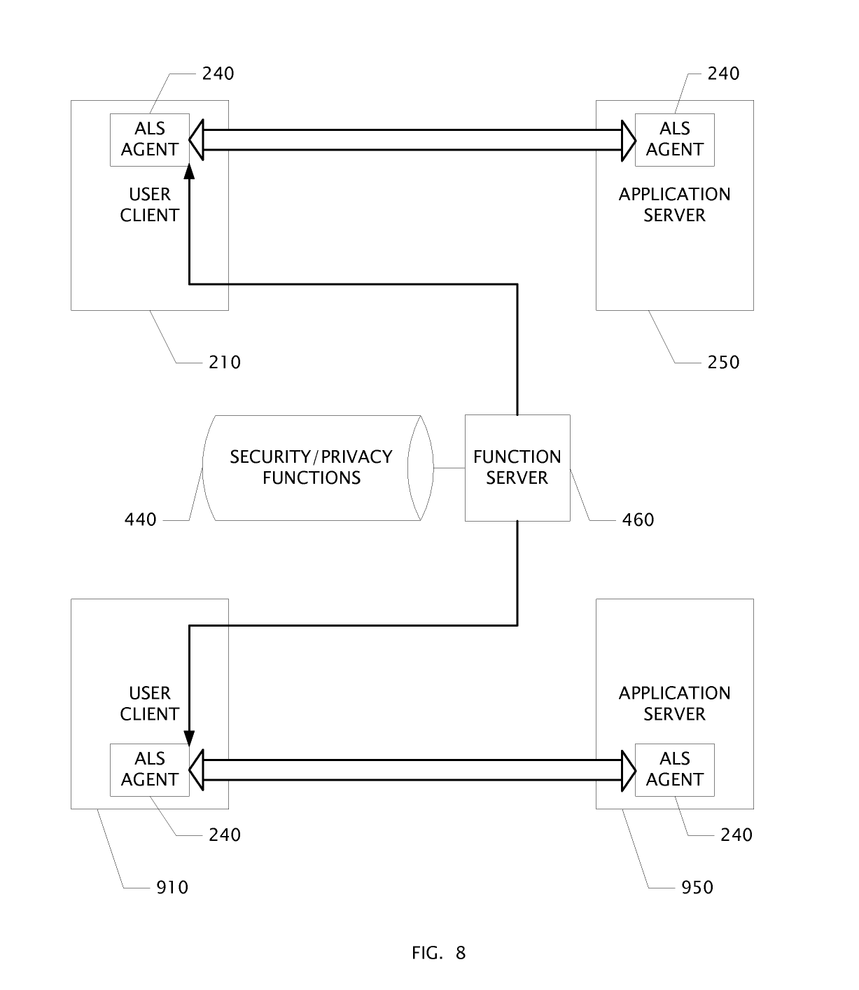

Referring now to FIG. 8, in an embodiment, one aspect of the invention enables secure operation without any certificates or Transport Layer Security protocols and of course does not depend on a Man-in-the-Middle attacker. The invention comprises a function server 460 coupled to a Security/Privacy Functions store 440 which is referenced by application servers 250-950 having an Application Layer Security agent 240. Responsive to requests from user clients 210-910, the function store selects and provides functions which install ALS agents within the user clients and negotiate a connection between the user client and the application server which protects usernames, passwords, and data transferred between the server and the client without relying on certificate authorities or signed certificates.

In an other embodiment of the invention provides an alternate data communication channel. One or more application/user trusted proxies are coupled through the Internet between the user client and the server. Upon receiving a request for a resource from the user client, the server includes a proxy redirection function into the response. Upon receiving the response, the user client avoids the MITM proxy.

In an embodiment, an function repository is available on the public Internet coupled to the user client. The user client user may independently install security/privacy functions directly from the function repository. When a user client requests a resource from the server, it receives a message to install a security/privacy application when one is not already detected. In this embodiment, the server does not provision the security/privacy function but checks the configuration of the user client and suggests that such functions be obtained from conventional sources of trusted plugins, extensions, and utilities.

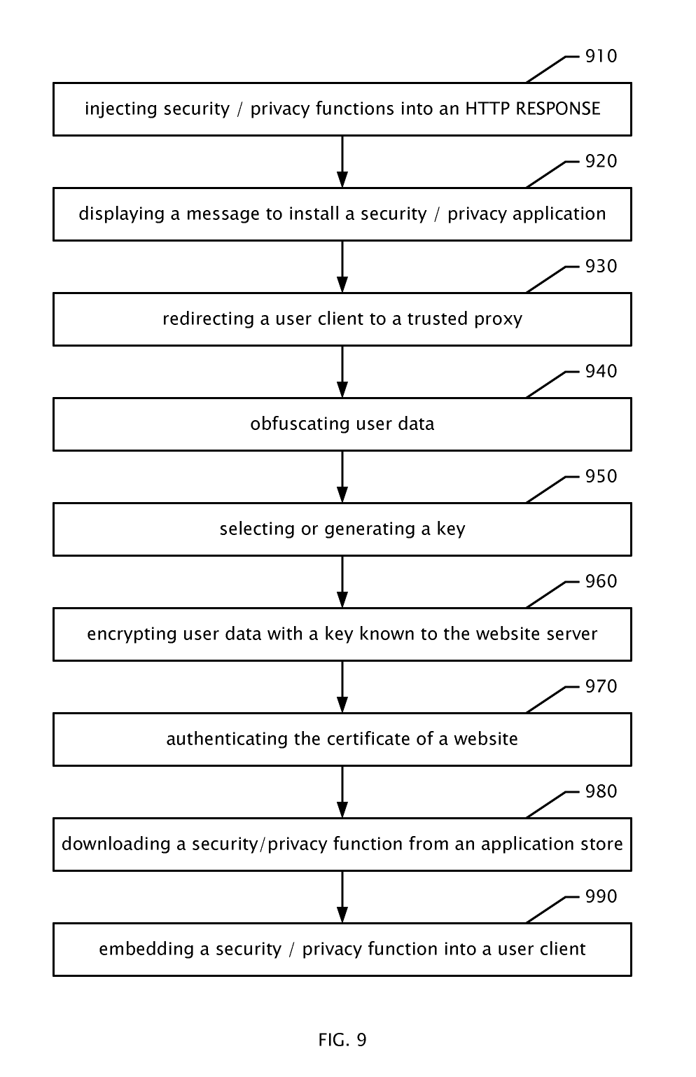

It is understood that circuit for the above functions may be carried out by one or more processors configured by software program products encoded on non-transitory media with computer executable instructions for one of more of the method steps of FIG. 9:
injecting security/privacy functions into an HTTP RESPONSE 910;
displaying a message to install a security/privacy application 920;
redirecting a user client to a trusted proxy 930;
obfuscating user data 940;
selecting or generating a key 950;
encrypting user data with a key known to the website server 960;
authenticating the certificate of a website 970;
downloading a security/privacy function from an application store 980; and
embedding a security/privacy function into a user client 990.

### Means, Embodiments, and Structures

Embodiments of the present invention may be practiced with various computer system configurations including hand-held devices, microprocessor systems, microprocessor-based or programmable consumer electronics, minicomputers, mainframe computers and the like.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated.

Any of the operations described herein that form part of the invention are useful machine operations. The invention also related to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. References to a computer readable medium mean any of well-known non-transitory tangible media.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

### CONCLUSION

The present invention is easily distinguished from conventional systems by initializing a second encrypted tunnel within a first encrypted tunnel provided by a conventional SSL/TLS connection. The present invention does not depend on Certificate Authorities or signed certificates and is not vulnerable to a Man-in-the-Middle attacker. The present invention obfuscates the user's identity before transmitting it from the user client. The present invention supports user clients which have not been preconfigured with software for security agents. The present invention includes configuring a browser to operate with cloud provisioned services.

What is claimed is:

1. A method for operating a application server comprising:
providing a resource at a uniform resource identifier;
receiving an http or https request;
transmitting an http or https response which includes a function;
receiving data that has been transformed by the function; and
removing the transformation of data which was operated on by the function.

2. The method of claim 1 wherein the function comprises a javascript program.

3. The method of claim 1 wherein the function comprises a flash program.

4. The method of claim 1 wherein the function obfuscates a form field before it is uploaded to an application web server.

5. The method of claim 1 wherein the function encrypts contents of a form field before it is uploaded to an application web server.

6. An apparatus comprising a server and a security/privacy function repository communicatively coupled to a network interface whereby security/privacy functions are selected and included with responses when a resource is requested by a user client.

7. The security/privacy function repository of claim 6 communicatively coupled to a plurality of servers which may select from available security/privacy functions to reference in response to a request from a user client.

8. The apparatus of claim 6 configured to provision a function to a user client when a connection to a server is requested by a user client.

9. The apparatus of claim 6 further comprising a security/privacy function repository comprising at least one of: instructions to include security/privacy functions in an HTTP RESPONSE;
instructions to display a message to install a security/privacy application;
instructions to redirect a user client to a trusted proxy;
instructions to obfuscate user data;
instructions to select or generate a key;
instructions to encrypt user data with a key known to the website server;
instructions to authenticate the certificate of a website;
instructions to download a security/privacy function from an application store; and
instructions to embed a security/privacy function into a user client.

10. The security/privacy function store of claim 7 further configured as a publicly accessible application store coupled to the Internet.

11. A method for providing a service to configure a user client for a secure communication connection with a remote server comprising:
receiving a security/privacy function in response to a initiation of a connection to the remote server;
exchanging with the server parameters to mutually configure the user client and the remote server to transform data and remove the transformation;
operating the function on data within the user client to transform the data; and
transmitting the transformed data to the remote server.

12. The method of claim 11 wherein the function comprises a javascript program.

13. The method of claim 11 wherein the function comprises a flash program.

14. The method of claim 11 wherein the function obfuscates a form field before it is uploaded to an application web server.

15. The method of claim 11 wherein the function encrypts contents of a form field before it is uploaded to an application web server.

16. The method of claim 11 further comprises: providing a security/privacy function repository communicatively coupled to a network interface whereby security/privacy functions are selected and included with responses when a resource is requested by a user client.

17. The method of claim 11 wherein the security/privacy function repository is communicatively coupled to a plurality of servers which may select from available security/privacy functions.

18. The method of claim 11 wherein connection does not rely possession of a digital certificate signed by a trusted certificate authority.

19. The method of claim 17 wherein the security/privacy functions are selected from:
instructions to include security/privacy functions in an HTTP RESPONSE;
instructions to display a message to install a security/privacy application;
instructions to redirect a user client to a trusted proxy;
instructions to obfuscate user data;
instructions to select or generate a key;
instructions to encrypt user data with a key known to the website server;
instructions to authenticate the certificate of a website;
instructions to download a security/privacy function from an application store; and
instructions to embed a security/privacy function into a user client.

20. The method of claim 17 wherein providing the security/privacy function is operated as a service to multiple unaffiliated customers.
